(19) United States
(12) Patent Application Publication
(10) Pub. No.: US 2009/0079222 A1
(43) Pub. Date: Mar. 26, 2009

(54) Cover means for a displaceably mounted vehicle window pane

(76) Inventor: Melf Hansen, Gondelsheim (DE)

Correspondence Address: FLYNN THIEL BOUTELL & TANIS, P.C., 2026 RAMBLING ROAD, KALAMAZOO, MI, 49008-1631, US

(21) Appl. No.: 12/284,157

(22) Filed: Sep. 18, 2008

(30) Foreign Application Priority Data
Sep. 18, 2007 (DE) 102007045613.3

(51) Int. Cl. B60J 3/00

(52) U.S. Cl. 296/97.4; 296/97.1

(57) ABSTRACT

The invention relates to a cover means for a displaceably mounted vehicle window pane (3), including a sheet-like structure (20) and an extending element (24, 124) that is in operational engagement with the sheet-like structure (20), in which the sheet-like structure (20) may be moved by means of the extending element (24, 124) from a stowage position into a use position and/or from the use position into the stowage position, the vehicle window pane (3) is at least partly covered by the sheet-like structure (20) in the use position, and the extending element (24, 124) may be coupled to the vehicle window pane (3) for a transmission of motion. The invention further relates to a device including a displaceable vehicle window pane and a cover element, and a control means for a device of this kind.

The invention relates to a cover means for a displaceably mounted vehicle window pane, a device including a cover means and a displaceable vehicle window pane, and a control means for driving an actuating drive for a corresponding device.

To provide protection from sunbeams that have a disruptive effect when they fall on vehicle windows, in particular vehicle side windows and/or panoramic windows, it is generally known to mount sun screen elements. These are secured releasably to the vehicle window panes, for example by means of rubber stops. When not in use, such elements have to be stowed in the vehicle.

In addition, cover means are known which are mounted in the vehicle such that they may be moved between a stowage position and a use position, manually or by means of an actuating drive. Such cover means, which take the form for example of sun-excluding roller blinds or non-opaque roller blinds, have a sheet-like structure which a user puts into a desired position manually. For greater convenience, an actuating drive may be provided which makes it possible to move the sheet-like structure fully or semi-automatically. For this actuating drive, however, the corresponding amount of stowage space has to be provided in a vehicle door or a vehicle roof.

An object of the invention is to provide a cover means which allows a vehicle window pane to be at least partly covered in a simple manner. It is a further object of the invention to provide a device including a corresponding cover means and a control means for a device of this kind.

This object is achieved by a cover means for a displaceably mounted vehicle window pane, including a sheet-like structure and an extending element that is in operational engagement with the sheet-like structure, in which the sheet-like structure may be moved by means of the extending element from a stowage position into a use position and/or from the use position into the stowage position, the vehicle window pane is at least partly covered by the sheet-like structure in the use position, and the extending element may be coupled to the vehicle window pane for a transmission of motion from the vehicle window pane to the extending element, for movement into the use position or into the stowage position. Within the context of the invention, the term “couple” is understood to mean a connection that may be made and released without tools.

The extending element is for example an extending profiled piece which is connected to a free edge of the cover means. By coupling the extending element to the vehicle window pane, it is possible to dispense with a separate actuating drive for the sheet-like structure. The sheet-like structure is moved with the vehicle window pane. Furthermore, it is possible to release a coupling between the extending element and the vehicle window pane, with the result that the vehicle window pane may also be moved independently of the flexible sheet-like structure.

The vehicle window pane is for example in the form of a side window pane, a slidable roof pane or the like. In an embodiment, the flexible sheet-like structure is mounted at least partly on a winding pin, such that it may be wound up and/or unwound. The winding pin makes it possible to stow the sheet-like structure in the stowage position, reliably and in a space-saving manner. Here, in an embodiment the winding pin includes a force element, in particular a winding spring, the sheet-like structure being unwound in opposition to the force of the force element.

In an embodiment of the invention, a coupling mechanism having a switch element, in particular a displaceable switching carriage, is provided for coupling and/or uncoupling. By moving the switch element, the extending element is coupled to the vehicle window pane, or a coupling is released. In an embodiment, the switch element is moved by a suitable actuating drive.

In an advantageous embodiment, the coupling mechanism includes a push-push mechanism, in particular a cardioid locking means. Here, the term “push-push mechanism” is used to mean a locking mechanism in which both locking and release take place as a result of a movement in the same direction, with the movement preferably being performable by applying a (pushing) force in opposition to the restoring force of a restoring element such as a restoring spring. A mechanism of this kind is also called a ballpoint pen mechanism. Such a mechanism can be produced in a simple way with a slideway-type guide in so-called cardioid form.

In a further embodiment of the invention, the switch element, in particular the switching carriage, has a control face which cooperates with an entrainer mounted on the vehicle window pane, for actuating the switch element. By moving the pane into a switching position, the entrainer that is provided on the vehicle window pane is moved into a position in which the entrainer cooperates with the control face and so moves the switching carriage. Actuating the coupling mechanism thus takes place indirectly by moving the vehicle window pane. In an embodiment, the switching carriage is mounted such that it is displaceable transversely, in particular substantially at a right angle, in relation to a direction of displacing the vehicle window pane in a plane with the vehicle window pane or parallel thereto. Here, the entrainer preferably also serves as the coupling element, with the result that additional elements on the vehicle window pane for coupling to the sheet-like structure may be dispensed with.

In an advantageous embodiment, the extending element that is in operational engagement with the sheet-like structure may be coupled to the vehicle window pane form-fittingly and/or force-fittingly. Here, secure transmission of motion is achieved when the vehicle window pane is displaced, with a transmission of motion in both directions of displacement preferably being possible.

This object is further achieved by a device for covering a vehicle window opening, including a displaceably mountable vehicle window pane, a sheet-like structure, an extending element that is in operational engagement with the sheet-like structure—the flexible sheet-like structure being movable by means of the extending element out of a stowage position into a use position and/or out of the use position into the stowage position, with the vehicle window pane at least partly covered by the sheet-like structure in the use position—and at least one coupling element, it being possible for the extending element to be coupled to the vehicle window pane for a transmission of motion by way of the coupling element, for movement into the use position or into the stowage position.

As a result of a coupling element according to the invention, it is possible to dispense with a separate drive for moving the sheet-like structure. Moving the sheet-like structure is in this case performed by way of an actuating mechanism of the vehicle window, it being possible for example to provide a manual actuating mechanism for adjustment by means of a crank.

In an advantageous embodiment, a coupling mechanism which may be actuated by displacing the vehicle window pane into a switching position is provided. By displacing the vehicle window pane into the switching position, here either the (flexible) sheet-like structure is coupled to the vehicle window pane or it is uncoupled therefrom. Subsequent movement of the vehicle window pane is then performed accordingly, with or without the (flexible) sheet-like structure. The switching position is preferably located outside a movement path that is provided for opening and closing the vehicle window pane. During movement along the movement path, no coupling or uncoupling takes place. By moving the vehicle window pane beyond the movement path that is required for opening and closing the window opening with the vehicle window pane, the vehicle window pane can be put in the switching position for coupling and uncoupling.

In an advantageous embodiment, an actuating mechanism for moving the vehicle window pane has a controllable and/or regulable actuating drive. The actuating drive makes it possible to move the vehicle window pane simply without the additional application of force by the user. Moreover, remote-controlled movement of the vehicle window pane, for example from a driver's seat, is possible. For this, corresponding actuator switches or the like may be provided in the region of the driver's seat.

In a further embodiment of the invention, the actuating drive may be triggered or regulated by a control means such that the switching position may be adopted selectively. Here, selection is performed for example by way of an actuator switch and/or a switch panel. If, for example, the selection “Open window” is made, then the switching position is not adopted. With a selection “Shade” and/or “Remove shade”, on the other hand, the switching position for coupling to the sheet-like structure or uncoupling the sheet-like structure is adopted.

The object is further achieved by a control means for a device according to the invention, in which an actuating drive for coupling the extending element to the vehicle window pane may be triggered by the control means. With an appropriate control means, remote-controlled actuation of a coupling mechanism is for example possible.

In an embodiment of the invention, the actuating drive is integrated in an actuating mechanism for moving the vehicle window pane. With an appropriate actuating mechanism, remote-controlled displacement of the vehicle window pane is possible without the additional application of force by the user. Integrating the actuating drive of the coupling mechanism in the actuating drive of the vehicle window pane makes a particularly compact construction possible.

In an advantageous embodiment, the actuating drive may be triggered or regulated by the control means such that the vehicle window pane may adopt a switching position selectively, it being possible to actuate a coupling mechanism by adopting the switching position. Here, in an embodiment, the actuating drive is triggered by the control means as a function of a position of an actuator switch or the like.

Further advantages of the invention will become apparent from the description that follows, of exemplary embodiments of the invention, which are illustrated diagrammatically in the drawings. Identical or similar components are given the same reference numerals in the drawings. Features that are described or illustrated as part of one exemplary embodiment may equally be applied in another exemplary embodiment to arrive at a further embodiment of the invention.

In the drawings:

FIG. 1 shows a device according to the invention for covering a vehicle window opening, in a sectional view;

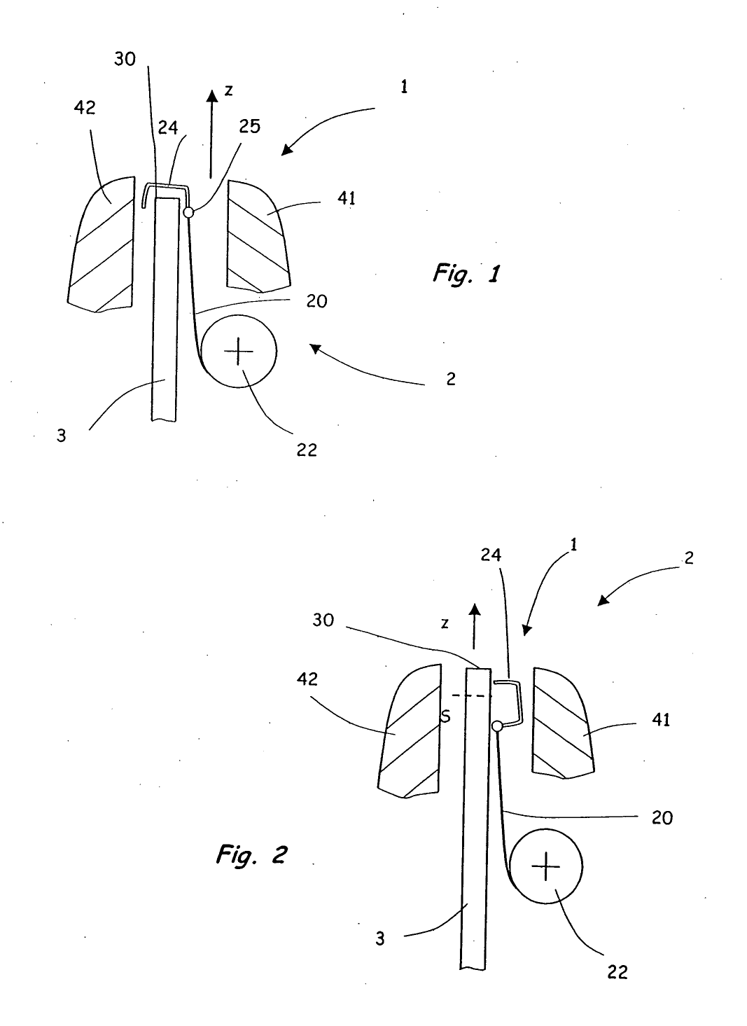

FIG. 2 shows the device according to FIG. 1 with a vehicle window pane outside a switching position, in a sectional view;

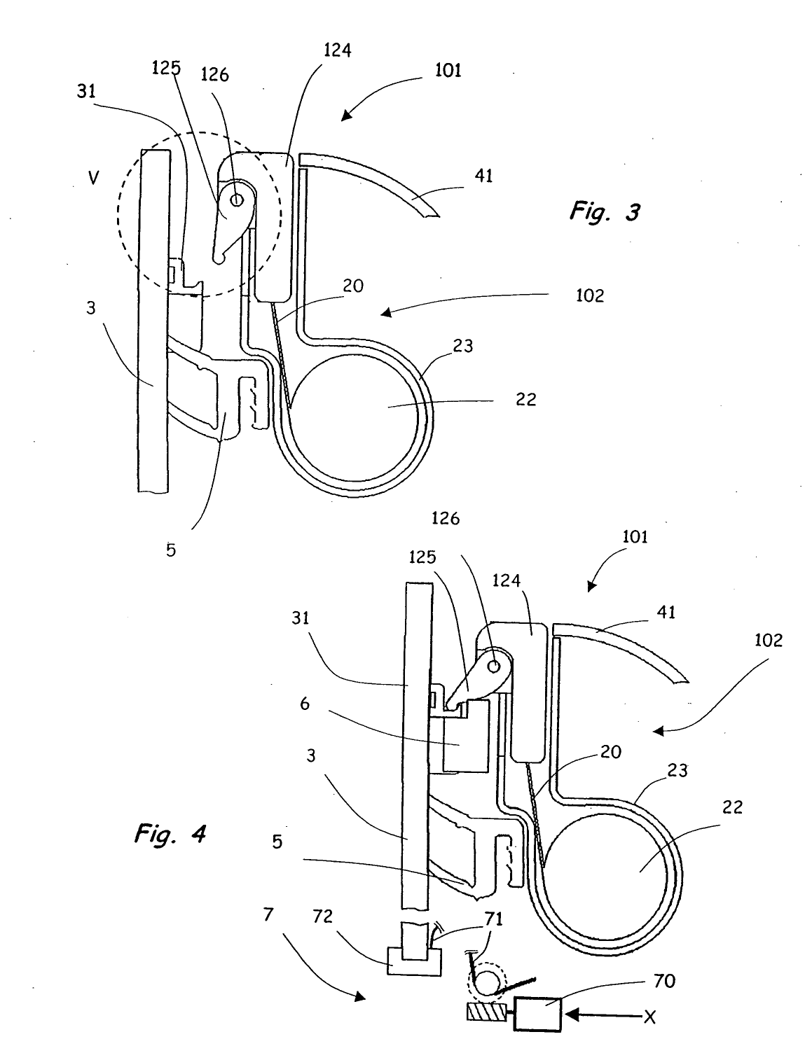

FIG. 3 shows an alternative embodiment of a device according to the invention for covering a vehicle window opening, in a sectional view;

FIG. 4 shows the device according to FIG. 3 with a vehicle window pane in a switching position, in a sectional view;

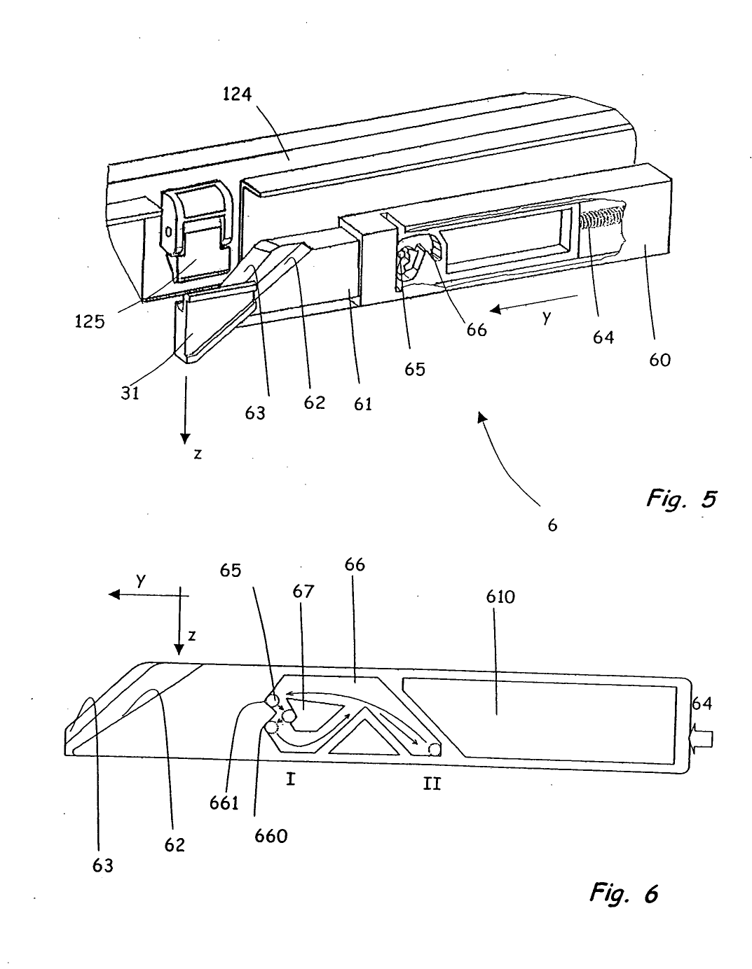

FIG. 5 shows a detail V according to FIG. 3, in a perspective illustration;

FIG. 6 shows a slide for a switching carriage of a coupling mechanism, in a side view;

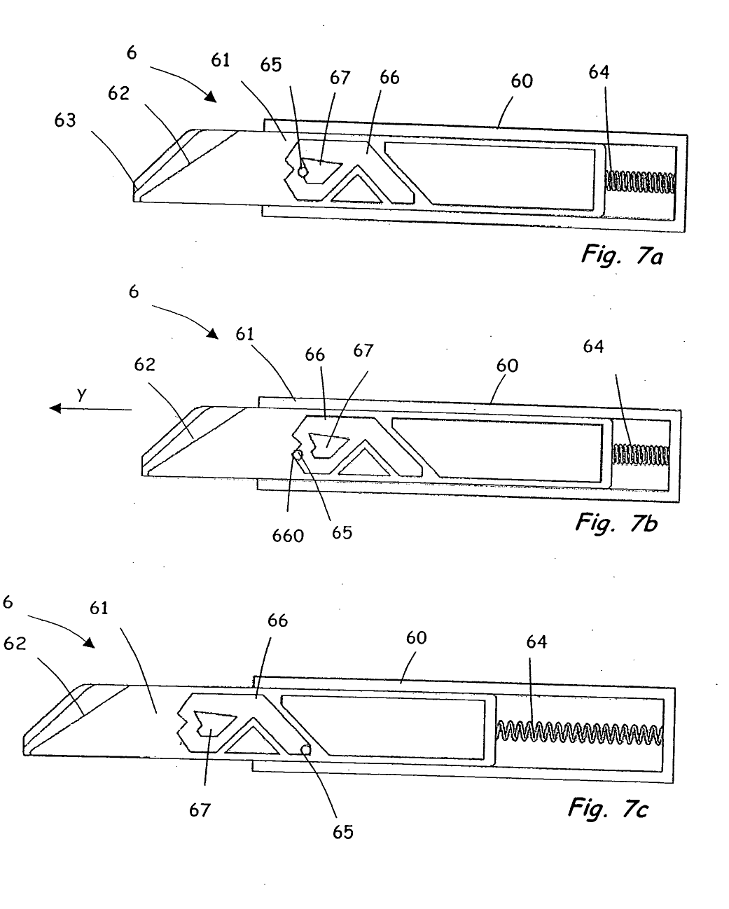

FIG. 7a shows a switching carriage in a first position, in a partly cut-away side view;

FIG. 7b shows the switching carriage in a second position, in a partly cut-away side view; and

FIG. 7c shows the switching carriage in a third position, in a partly cut-away side view.

FIG. 1 shows a device 1 according to the invention for covering a vehicle window opening (which is not illustrated), in a sectional side view. The device 1 includes a cover means 2 and a displaceably mounted vehicle window pane 3, in which the vehicle window pane 3 is displaceable in a direction z for closing the window opening, or in opposition to the direction z for opening the window opening. In the exemplary embodiment illustrated, the device 1 is arranged at a window breast between an inner wall 41 and an outer wall 42 of a rear side door (not illustrated further) of the motor vehicle.

The cover means 2 includes a flexible sheet-like structure 20, which is movable between a stowage position (illustrated in FIG. 1) and a use position (not illustrated), with the sheet-like structure 20 at least partly covering the vehicle window pane 3 in the use position. The cover means 2 that is illustrated further includes a winding pin 22 onto which the flexible sheet-like structure 20 may be wound in the stowage position to save space when it is not in use. For this, a winding spring (not illustrated) may be provided for winding the sheet-like structure 20 onto the winding pin 22.

For unwinding and moving the flexible sheet-like structure 20, the cover means 2 includes an extending element 24 which is in operational engagement with the sheet-like structure 20 and which may be coupled to the vehicle window pane 3 for the transmission of motion. For coupling to the vehicle window pane 3, the extending element 24 in the exemplary embodiment illustrated is connected to the sheet-like structure 20 by way of a pivot joint or hinge 25. The extending element 24, which in the exemplary embodiment illustrated is U-shaped in cross section, may be pivoted by means of the hinge 25 such that, as illustrated in FIG. 1, it reaches around the vehicle window pane 3 at the upper edge 30 thereof. When the vehicle window pane 3 is moved in the direction z, to close the window opening, the motion of the vehicle window pane 3 is transmitted to the cover means 2.

FIG. 2 shows the device 1 according to FIG. 1, with the vehicle window pane 3 moved into a position in which the upper edge 30 of the vehicle window pane 3 is located above a plane S. In this position, the vehicle window pane 3 prevents the extending element 24 from automatically lying over the vehicle window pane 3. Only once a position that is illustrated for example in FIG. 1 is adopted does it become possible for the extending element 24 to be pivoted automatically, for example by means of the pre-tension of a spring (not illustrated) , and thus for the cover means 2 to be coupled to the vehicle window pane 3 for a transmission of motion.

When a vehicle window opening, for example a side window opening, is opened by moving the vehicle window pane 3, the latter is moved for example at most as far as the position illustrated in FIG. 2, in which the upper edge 30 lies above the plane S. If the vehicle window pane 3 is closed by moving out of the position illustrated in FIG. 2 in the direction z, then the cover means 2 remains in the stowage position illustrated in FIG. 2. If, on the other hand, the vehicle window pane 3 is to be covered by the cover means 2, then the vehicle window pane 3 may be moved into a switching position in which the upper edge 30 comes to lie below the plane S. In this position, the extending element 24 is pivoted around the upper edge 30 of the vehicle window pane 3—as illustrated in FIG. 1. When the vehicle window pane 3 is moved again to close the window opening, the vehicle window pane 3 is covered by the flexible sheet-like structure 20. Here, the entrainer 24 may be uncoupled from the vehicle window pane 3 for example manually and/or by a mechanism which is not illustrated in FIGS. 1 and 2.

The vehicle window pane 3 may be moved manually and/or by way of an actuating drive. To move the cover means 2, no additional actuating drive is required. In an embodiment, the actuating drive for moving the vehicle window pane 3 may be triggered such that the vehicle window pane 3 can adopt different positions. By opening the vehicle window pane 3 beyond a conventional movement path and by moving the vehicle window pane 3 into a switching position, remote-controlled coupling of the extending element 24 to the vehicle window pane 3 is made possible, for example by a driver of the vehicle, from a driver's seat.

FIG. 3 shows diagrammatically a device 101 according to the invention, including a cover means 102 and a vehicle window pane 3. The device 101 corresponds substantially to the device 1 in FIG. 1. Here, the same reference numerals are used for the same components, and no detailed description is given of components that have already been described. In the exemplary embodiment illustrated, the winding pin 22 is mounted in a cartridge 23. Furthermore, for the purpose of sealing, a sealing lip 5 is provided in the exemplary embodiment illustrated.

The extending element takes the form of an extending profiled piece 124 which is connected to the flexible sheet-like structure 20 at the free edge thereof, the opposite edge to the winding pin 22. A pivotal entrainer 125 is mounted to pivot on the extending element 124 about a pin 126. The pin 126 extends substantially parallel to the longitudinal direction of the extending profiled piece 124.

In the exemplary embodiment illustrated, a second entrainer 31 is fixedly connected to the vehicle window pane 3. The second entrainer 31 is for example glued to the vehicle window pane 3 and/or fixedly mounted thereon in another way. The entrainer 125 that is connected to the sheet-like structure 20 and the- entrainer 31 that is connected to the vehicle window pane 3 have mutually complementary contours, with the result that the entrainers 125, 31 can engage in one another for the transmission of motion. To this end, the entrainer 125 is pivoted about the pin 126.

To pivot and couple the entrainer 125 with the entrainer 31 of the vehicle window pane 3, a switch element, in particular a displaceable switching carriage, may be provided.

FIG. 4 shows the device 101 according to FIG. 3, with the entrainer 125 displaced by a switching carriage 6 such that the entrainer 125 comes into engagement with the entrainer 31 that is mounted on the vehicle window pane 3. The switching carriage 6 is part of a coupling mechanism. In the embodiment illustrated, the coupling mechanism is switched by a push-push mechanism, with the adoption of a common switching position allowing the entrainer 125 to be coupled to the vehicle window pane 3 or uncoupled therefrom. If the switching position is not adopted, by contrast, the condition is not changed, that is to say the entrainer 125 remains uncoupled or coupled, as the case may be. Here, the switching position is outside a movement path that is required for opening and closing the vehicle window pane 3. Thus, coupling or uncoupling is performed by moving the vehicle window pane 3 into a position outside the movement path.

To this end, the vehicle window pane 3 is movable by an actuating drive 7 including a motor 70 (illustrated diagrammatically). For moving the vehicle window pane 3, a motion of the output shaft of the motor 70 is transmitted, by way of a Bowden cable 71, to a window support 72. The motor 70 may be triggered by way of a control signal X for driving the vehicle window pane 3, it being possible for a switching position to be adopted selectively as a function of the control signal X.

FIG. 5 shows diagrammatically a detail V according to FIG. 3 in a perspective illustration, in which the vehicle window pane 3 according to FIG. 3 has not been illustrated, for the sake of better clarity. As can be seen from FIG. 5, the switching carriage 6 that is illustrated is made in two parts, including a sleeve 60 and a slide 61 that is mounted displaceably therein. The slide 61 has two switching faces 62, 63 that project out of the sleeve 60. Here, a force element 64, which takes the form of a spring, acts on the slide 61 with a force in the direction y, such that the slide 61 is forced out of the sleeve 60. When there is a movement in the z direction, the entrainer 31 on the window side, which is arranged rigidly on the vehicle window pane 3 illustrated in FIG. 3, cooperates with the switching face 62 such that when the entrainer 31 makes contact with the switching face 62 the slide 61 is displaced in opposition to the force of the spring 64 that is arranged in the sleeve 60. The second switching face 63 cooperates with the entrainer 125 that is arranged on the extending profiled piece 124, the contact causing the entrainer 125 to be pivoted such that the entrainer 125 is coupled to the entrainer 31 on the window side.

Provided on the sleeve 60 is a pin 65 that is mounted to be displaceable in the z direction and cooperates with a cardioid slideway 66 that is made on the slide 61.

FIG. 6 shows diagrammatically a possible movement of the pin 65 in relation to the cardioid slideway 66. The slideway 66 is delimited by a cutout in the slide 61 and a latching element 67 arranged in the cutout. The slide 61 is loaded in the y direction by the force element 64 (which is illustrated diagrammatically, by an arrow). When the pin 65 is in a first latching position I, the latching element 67 limits movement of the slide 61 in the y direction. The slide 61 is displaceable in opposition to the force of the force element 64, with movement being limited by the abutment of the pin 65 against a lower curve 660 of the cardioid shape of the slideway 66. Because of the force exerted by the force element 64, this position is not stable, and the slide 61 is moved out of this position in the y direction again. This means the pin 65 comes to lie in a rear latching position II. If the slide 61 is displaced again in opposition to the force illustrated by the arrow, the pin 65 is guided such that it comes to lie against the upper curve 661 of the cardioid shape. Without any external exertion to displace the slide 61, the force element 64 returns the slide 61 to the latching position I.

Depending on the latching position I, II, the slide 61 projects out of the sleeve 60 that is illustrated in FIG. 5 by different extents. If the slide 61 is in the rear latching position II, the slide 61 projects out of the sleeve 60 far enough for the switching face 63 to cooperate with the entrainer 125 that is mounted pivotably on the extending profiled piece 124. Here, the entrainer 125 is pivoted such that the entrainer 125 comes into engagement with the entrainer 31, which has a form complementary thereto, on the vehicle window pane. This couples the extending profiled piece 124 to the vehicle window pane illustrated in FIG. 3. To save on weight, the slide 61 illustrated has a cutout 610.

FIGS. 7a to 7c show diagrammatically the switching carriage 6 in a partly cut-away side view, various switching positions being illustrated. In a first switching position that is illustrated in FIG. 7a, the pin 65 latches with the latching element 67 such that any movement of the slide 61 in the y direction is prevented because of a restoring force of the spring 64. Here, the entrainer 125 that is illustrated in FIG. 5 is not pivoted, and when the vehicle window pane 3 is raised, the latter is not coupled to the extending profiled piece 124.

When the switching position is (again) adopted, the entrainer 31, which is not illustrated in FIGS. 7a to 7c and is connected to the vehicle window pane (similarly not illustrated), cooperates with the switching face 62 such that the slide 61 is displaced in opposition to the force of the spring 64. Suitable shaping of the latching element 67 means that the pin 65 is moved such that it is guided in the lower curve 660 of the cardioid shape. This position of the carriage 61 is illustrated in the position of 7b.

In the absence of the action of a force and/or movement at the switching face 62, the slide 61 is moved by the force element 64 such that the pin 65 latches into the second latching position II of the cardioid slideway 66. This second latching position is illustrated in FIG. 7c. Here, the slide 61 is moved in the y direction such that the switching face 63 can cooperate with the entrainer 125 that is arranged on the extending profiled piece 124 according to FIG. 5. This pivots the entrainer 125 such that it is coupled to the entrainer 31, also illustrated in FIG. 5. If the vehicle window pane 3 illustrated in FIG. 3 is then closed again, the cover means 102 is moved such that the sheet-like structure 20 at least partly covers the vehicle window pane 3.

If the slide 61 is moved again in opposition to the y direction as a result of the switching position being adopted again, the pin 65 again latches into the latching position I, II (illustrated in FIG. 7a) on the latching element 67. As a result the entrainers 31, 124 that are illustrated in FIG. 5 are not coupled again when the vehicle window pane 3 is moved out of the switching position.

In operation, it is possible for example, for the purpose of covering the vehicle window pane 3 with the flexible sheet-like structure 20, for an operating element such as a button, a switch panel or any other kind of human/machine interface to generate a signal for the actuating drive 7, which is illustrated by way of example in FIG. 4, by means of a control drive (not illustrated), such that the vehicle window pane 3 adopts a switching position. In this switching position, the entrainer 31 cooperates with the slide 61 such that an extending element that is not coupled to the vehicle window pane 3—for example an extending profiled piece 124 according to FIGS. 3 to 5—is coupled to a corresponding element of the vehicle window pane 3—for example the entrainer 31 according to FIGS. 3 to 5. It is similarly possible to adopt the switching position for removing the flexible sheet-like structure 20 from the vehicle window pane 3. In addition, it is possible for the actuating drive 7 to move the vehicle window pane 3 within a movement path, for opening and closing a window opening. As long as a switching position is outside the movement path of the vehicle window pane 3, there is no coupling or uncoupling of the cover means 102 to or from the vehicle window pane 3.

1. Cover means for a displaceably mounted vehicle window pane (3), including a sheet-like structure (20) and an extending element (24, 124) that is in operational engagement with the sheet-like structure (20), in which the sheet-like structure (20) may be moved by means of the extending element (24, 124) from a stowage position into a use position and/or from the use position into the stowage position, and the vehicle window pane (3) is at least partly covered by the sheet-like structure (20) in the use position, characterized in that the extending element (24, 124) may be coupled to the vehicle window pane (3) for a transmission of motion.

2. Cover means according to claim 1, characterized by a coupling mechanism having a switch element, in particular a displaceable switching carriage (6).

3. Cover means according to claim 1, characterized in that the coupling mechanism includes a push-push mechanism (65, 66), in particular a cardioid locking means.

4. Cover means according to claim 2, characterized in that the switch element, in particular the switching carriage (6), has a control face (62) which cooperates with an entrainer (31) mounted on the vehicle window pane (3), for moving the switch element.

5. Cover means according to claim 1, characterized in that the extending element (24, 124) that is in operational engagement with the sheet-like structure (20) may be coupled to the vehicle window pane (3) form-fittingly and/or force-fittingly.

6. Device for covering a vehicle window opening, including a displaceably mountable vehicle window pane (3) and a cover means (2, 102) according to claim 1.

7. Device according to claim 6, characterized by a coupling mechanism for coupling an extending element (24, 124) of the cover means (2, 102) to the vehicle window pane (3).

8. Device according to claim 7, characterized in that the coupling mechanism may be actuated by displacing the vehicle window pane (3) into a switching position.

9. Device according to claim 6, characterized in that an actuating mechanism for moving the vehicle window pane (3) has a controllable and/or regulable actuating drive (7).

10. Device according to claim 9, characterized in that the actuating drive (7) may be triggered or regulated by a control means such that the switching position may be adopted selectively.

11. Control means for a device according to claim 6, in which an actuating drive (7) for coupling the extending element (24, 124) to the vehicle window pane (3) may be triggered by the control means.

12. Control means according to claim 11, characterized in that the actuating drive (7) is integrated in an actuating mechanism for moving the vehicle window pane (3).

13. Control means according to claim 12, characterized in that the actuating drive (7) may be triggered or regulated by the control means such that the switching position may be adopted selectively.
